(19) United States
(12) Patent Application Publication
(10) Pub. No.: US 2003/0192422 A1
(43) Pub. Date: Oct. 16, 2003

(54) Drumshell laminate

(75) Inventor: Remo D. Belli, Sherman Oaks, CA (US)

Correspondence Address: RAPKIN, GITLIN & BEAUMONT, 5855 TOPANGA CANYON BLVD.,, SUITE 301, WOODLAND, CA, 91367, US

(73) Assignee: REMO, INC.

(21) Appl. No.: 10/122,171

(22) Filed: Apr. 15, 2002

(51) Int. Cl. G10D 13/02

(52) U.S. Cl. 84/411 R

(57) ABSTRACT

An improved drumshell construction comprising a first layer of sheet material having elastic properties, a second layer of sheet material in mating engagement with the first layer of sheet material, a means to bond the two layers together, wherein the elastic modules of the first layer of material is imparted to the second layer of material to enhance the formation of a drumshell having varying sound absorptive and radiating characteristics to control and enhance the timbre of the drumhead.

### BACKGROUND OF THE INVENTION

1. Field of the Invention

The present invention relates to musical drums and, more particularly, to an improved construction of a drumshell, and a process of producing a drumshell.

2. Description of the Prior Art

The quality and intensity of sounds produced by a musical drum derive from two principal components, namely the drumhead and the drumshell. The drumhead contributes to the instrument's sound characteristics when struck by an object, such as a drumstick, mallet or the like. The composition of the material used to construct the head, and the material's thickness, combine to produce a distinct sound. Various blends of synthetic plastic and fabric materials are normally employed to produce known sound characteristics. But no distinct sound can ever be realized until the head is actually struck and caused to vibrate.

Although the shell is also caused to vibrate whenever the head is struck, not a great deal of attention has been paid to this otherwise critical component in terms of its significant contribution to the instrument's harmonics. Since the shell is a vibrating medium, similar in certain respects to the head, and vibrations affect the drum's sound characteristics, it follows that the composition of the shell component is an extremely important consideration.

The drumshell determines the timbre, or quality, of the tone produced by the head. Timbre relates to the harmonics, whose relative intensities are determined by the amount of sound that the drumshell absorbs and radiates. Prior art drumshells are comprised of a variety of materials, including, for example, wood (solid or laminate), fibreglass and carbon-graphite. In some cases, these materials are blended to create a hybrid sound. However, none of these materials, either alone or in combination, are as cost effective to manufacture and have been capable of producing the wide range of intense and quality sounds as the drumshell composition of the present invention. More specifically, the combination of components that comprise the present invention are capable, in contrast to prior art drumshells, of producing vastly improved sound characteristics for use in a wide range of applications, including without limitation, orchestral, marching band, jazz, rock and ethnic percussion environments.

The present invention also includes an improved process for producing the drumshell.

### SUMMARY OF THE INVENTION

In its preferred embodiment, the present invention provides an improved drumshell construction comprising a first layer of sheet material having elastic properties, a second layer of sheet material joined in mating engagement with the first layer of sheet material, a means to bond the two layers together, wherein the elastic modulus of the first layer of material is imparted to the second layer of material to enable and facilitate the formation of a drumshell having varying and improved sound absorptive and radiating characteristics to control and enhance the timbre of the drumhead.

The first layer of sheet material can be comprised of a variety of materials, though polyester film is preferable. The second layer of sheet material also can be comprised of a variety of materials, including, for example, rigid phenol, epoxy based resin fiber board and wood veneer. Suitable adhesives or adhesive webbings are applied to bond the layers.

The present invention also includes a process for producing the drumshell. The process comprises a method of manufacturing the drumshell of the present invention that includes the steps of interposing the adhesive material between the layers of sheet materials, subjecting the bonded layers to heat, compressing the heated bonded layers until the materials become fused in a permanently compressed state, forming the fused heated materials into the shape of a drumshell and permitting the drumshell to cool while in a permanently compressed state.

Accordingly, it is an object of the present invention to provide an improved construction of a drumshell.

It is also an object of the present invention to provide an improved method of producing the drumshell.

It is another object of the present invention to provide a drumshell with specific and unique sound characteristics for use in concert with an orchestra and marching band, with a conventional drum set for playing a variety of types of music and in conjunction with ethnic percussion.

It is another object of the present invention to provide a drumshell with enhanced strength and overall flexibility enabling it to vibrate more freely and withstand impact.

It is yet another object of the present invention to provide a drumshell constructed of a bonded laminate wherein a component of the laminate contains elastic properties.

It is yet another object of the present invention to provide a drumshell constructed of a bonded laminate wherein the elastic modulus of one or more components of the laminate is imparted to certain other components to enable and facilitate the formation of the improved drumshell.

It is yet another object of the present invention to provide an improved drumshell having greatly enhanced and varying sound absorptive and radiating characteristics to better control and enhance the timbre of the drumhead.

It is yet another object of the present invention to provide an improved drumshell that is easy and cost effective to manufacture.

Other objects and advantages of the present invention will become apparent in the following specifications when considered in light of the attached drawings wherein a preferred embodiment of the invention is illustrated.

### BRIEF DESCRIPTION OF THE DRAWINGS

FIG. 1 is an exploded view of the present invention showing components of a laminate structure used to form a drumshell.

FIG. 2 is a cross-sectional view of the laminated form of the present invention shown in FIG. 1.

FIG. 3 is a cross-sectional view of the present invention showing multiple layers employed to form the laminate.

FIG. 4 is an elevational cross sectional view illustrating the steps in the manufacture of one type of laminate structure made in accordance with the present invention.

FIG. 5 is a perspective view of a laminate made in accordance with the present invention illustrating a step in the process of forming a drumshell.

FIG. 6 is a perspective view of a finished musical drum incorporating a drumshell formed from a laminate made in accordance with the present invention.

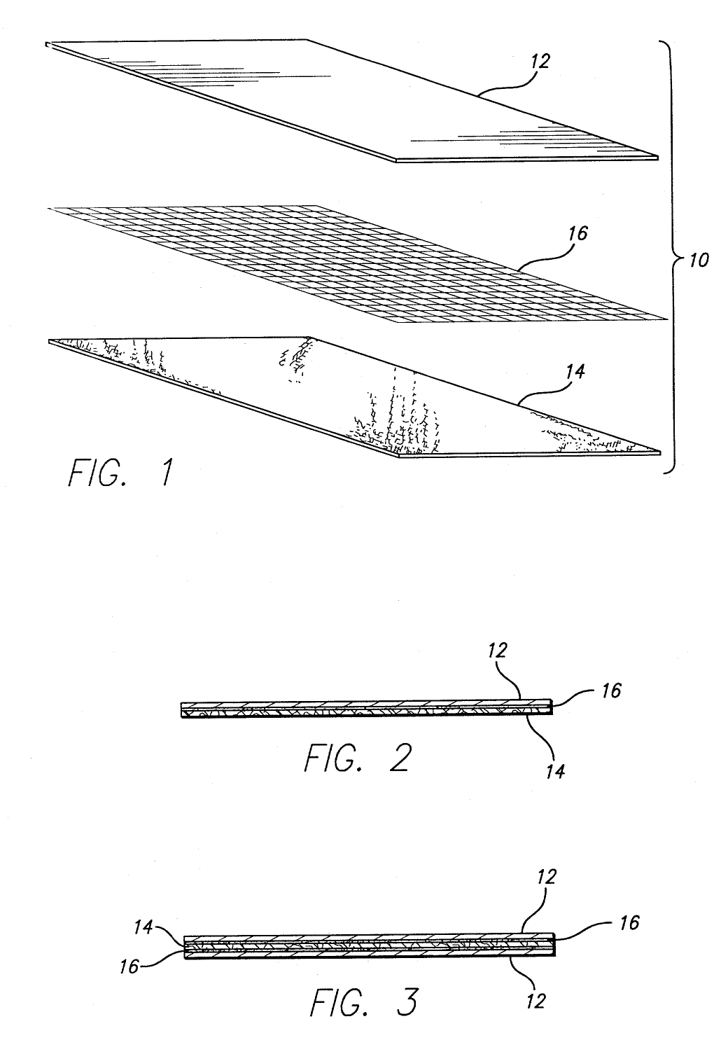

### DETAILED DESCRIPTION OF THE PREFERRED EMBODIMENT

Referring more particularly to the drawings, FIG. 1 is a perspective view of the present invention depicting the components of the laminate structure 10 prior to their being heated and compressed to form a drumshell. Laminate structure 10 is a composite comprised of a first layer of sheet material 12, a second layer of sheet material 14, with a layer of adhesive material 16 in between sheet materials 12 and 14 to securely bond sheet materials 12 and 14.

Sheet material 12 possesses elastic properties, which are imparted to sheet material 14 when the two sheets are joined and bonded to enable the laminate structure 10 to be more flexible in forming the laminate structure 10 into a cylindrical shaped drumshell 18. Sheet material 12 is preferably comprised of a synthetic composition, including, without limitation, polyester film and similar types of materials. Sheet material 14 may also be comprised of a variety of materials, including, without limitation, rigid phenol, epoxy based resin fiberboard and wood veneer. Material 16, which is used to bond sheet materials 12 and 14, is comprised of any suitable adhesive such as, for example, an adhesive web.

Depending on the needs of the user or the special requirements of the instrument, laminate structure 10 maybe comprised of multiple layers, as shown in FIG. 3. The number and composition of the layers will provide varying sound adsorptive and radiating characteristics necessary to control and enhance the timbre of the drumhead 20. The different blends of these layers and their varying thicknesses can be combined to produce numerous and very distinctive sounds. These vastly improved sounds and sound characteristics are useful in a wide range of applications, including, without limitation, orchestral, marching band, jazz, rock and ethnic percussion environments.

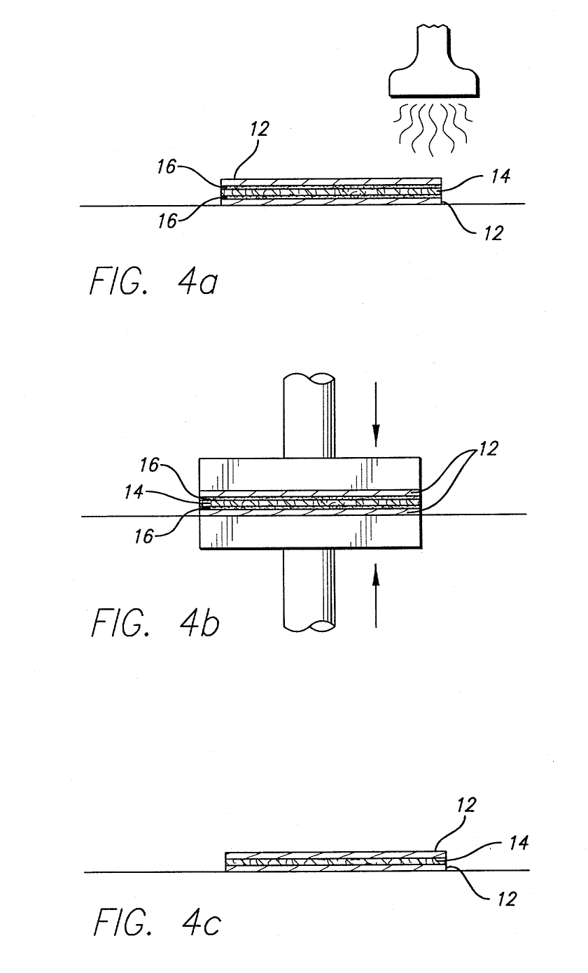

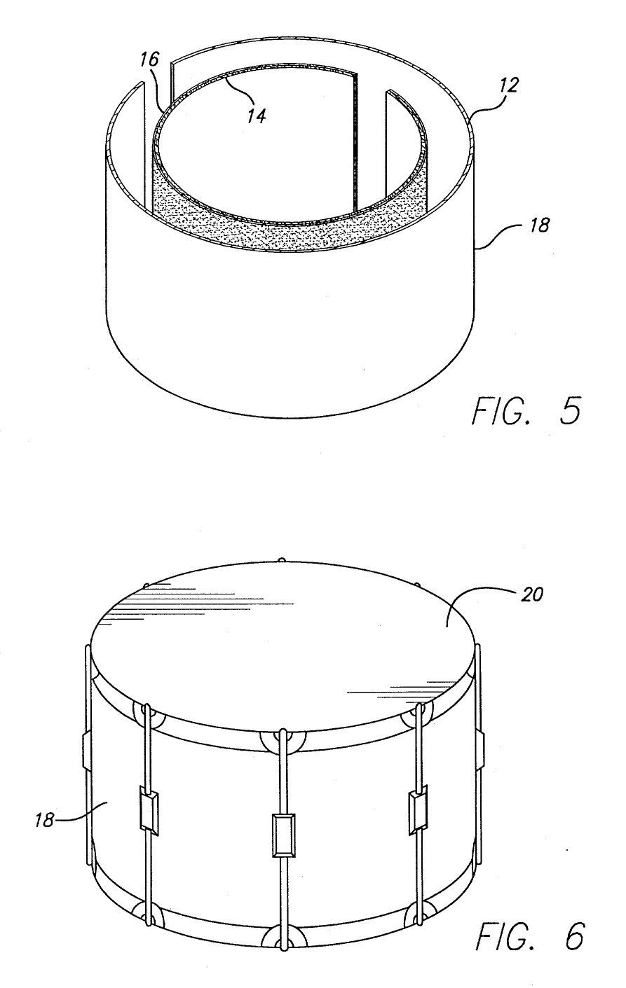

The present invention also includes the process depicted in FIG. 4 for producing drumshell 18 comprising the steps of interposing adhesive material 16 between layers of sheet materials 12 and 14, subjecting the bonded layers of sheet materials 12 and 14 to heat (FIG. 4a), compressing the heated bonded layers of sheet materials 12 and 14 until the layers of materials are joined in a permanently compressed state (FIGS. 4b and 4c), forming the fused heated materials into the shape of drumshell 18 (FIG. 5) and permitting the drumshell 18 to cool while in a permanently compressed state (not shown). The process can be employed utilizing a plurality of layers of materials in different combinations depending upon the intended musical application of the drum.

While the invention will be described in connection with a certain preferred embodiment, it is to be understood that it is not intended to limit the invention to that particular embodiment. Rather, it is intended to cover all alternatives, modifications and equivalents as may be included within the spirit and scope of the invention as defined by the appended claims.

1. A musical drum having a drumhead, and a drumshell constructed of a composite laminate, comprising:
a first layer of sheet material, said first layer of sheet material having elastic properties;
a second layer of sheet material joined in mating engagement with said first layer of sheet material;
A means to bond said first layer of sheet material and said second layer of sheet material;
wherein the elastic modulus of said first layer of sheet material is imparted to said second layer of sheet material to enable and facilitate the formation of the drumshell having varying sound adsorptive and radiating characteristics to control and enhance the timbre of said drumhead.

2. The invention of claim 1 wherein said first layer of sheet material comprises a polyester film.

3. The invention of claim 1 wherein said second layer of sheet material comprises a sheet of rigid phenol.

4. The invention of claim 1 wherein said second layer of sheet material comprises an epoxy based resin fiber board.

5. The invention of claim 1 wherein said second layer of sheet material comprises a wood veneer.

6. The invention of claim 1 wherein said means to bond comprises an adhesive material.

7. The invention of claim 1 wherein said means to bond comprises an adhesive web.

8. A musical drum having a drumhead, and a drumshell constructed of a composite laminate, comprising:
one or more layers of polyester sheet material, each of said layers of polyester sheet materials having elastic properties;
one or more layers of a second sheet material, said second sheet material being made of a material other than polyester, bonded in mating engagement with one or more layers of said first layer of polyester sheet material,
means to bond one or more layers of said polyester sheet material and one or more layers of said second sheet material; and,
wherein the elastic modulus of said one or more layers of said polyester sheet material is imparted to one or more layers of said second sheet material to enable and facilitate the formation of the drumshell with varying sound adsorptive and radiating characteristics to control and enhance the timbre of said drumhead.

9. A method of manufacturing the drumshell of the musical drum in claim 1 comprising:
interposing said adhesive material between said first layer of sheet material and said second layer of sheet material;
subjecting the combination of said adhesive material interposed between said first and second layers of sheet materials to heat;
compressing the combination of said adhesive material interposed between said first and second layers of sheet materials until said materials become fused in a permanently compressed state;
forming said fused heated materials into the shape of a drumshell; and
permitting said drumshell to cool while in said permanently compressed state.

10. A method of manufacturing the drumshell of the musical drum in claim 1 comprising:
interposing a first sheet of adhesive web between a first layer of sheet material and said second layer of sheet material, said combination of materials comprising a single laminate;
interposing a second sheet of adhesive web between two said single laminates, said combination of materials comprising a double laminate;
subjecting said single and double laminates simultaneously to heat and compression until said laminates become fused in a permanently compressed state;
forming said fused heated laminates into the shape of a drumshell; and
permitting said drumshell to cool while in said permanently compressed state.
